(19) United States
(12) Patent Application Publication
(10) Pub. No.: US 2025/0027410 A1
(43) Pub. Date: Jan. 23, 2025

(54) SYSTEM AND METHOD FOR ESTIMATING ROCK PARTICLE PROPERTIES BASED ON IMAGES AND GEOLOGICAL INFORMATION

(71) Applicant: Schlumberger Technology Corporation, Sugar Land, TX (US)

(72) Inventors: Tetsushi Yamada, Cambridge, MA (US); Simone Di Santo, Dhahran (SA); Karim Bondabou, Montpellier (FR); Romain Prioul, Concord, MA (US); Daniel Lockyer, Clamart (FR)

(21) Appl. No.: 18/779,870

(22) Filed: Jul. 22, 2024

Related U.S. Application Data
(60) Provisional application No. 63/514,691, filed on Jul. 20, 2023.

(51) Int. Cl. E21B 49/00; E21B 44/00; G06V 10/40; G06V 10/764

(52) U.S. Cl. CPC E21B 49/005; E21B 44/00; G06V 10/40; G06V 10/764

(57) ABSTRACT

Systems and methods are provided to analyze rock cuttings and measure physical lithological features of the rock cuttings. An image analysis workflow is provided, which includes multiple computational modules to automatically estimate relevant geological information from rock cuttings. Reference data, manual descriptions, and well log values are associated and used to determine rock properties of the rock cuttings. A software is developed for the image analysis, and results are displayed in various views.

### CROSS REFERENCE TO RELATED APPLICATION

This application claims priority to and the benefit of U.S. Provisional Application No. 63/514,691, filed on Jul. 20, 2023, the entirety of which is incorporated herein by reference.

### BACKGROUND

The present disclosure generally relates to systems and methods for estimating rock particle properties based on image similarity and geological information, and, more specifically, to the analysis of individual rock particles that are identified in the images of the rock particles.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Rock particles are usually a fundamental unit of domain-specific post-processing analysis that has been widely used in industry and scientific applications, including, but not limited to, space exploration, mining, civil engineering, geothermal, and oil and gas. Image data of the rock particles typically come from imaging systems that produce digital images or three-dimensional (3D) images from a laser scanner. Once rock particles are detected and segmented, they may be used to compute the rock particle properties such as size, shapes, textures, and other morphological, rock properties and petrophysical properties to answer domain-specific questions.

In oil and gas, geothermal, as well as scientific exploration applications, rock particles are produced during drilling activities. The rock particles are called rock cuttings (or caving's, depending on their sizes). Rock cuttings are generally used to identify lithology types for the subsurface characterization and are one of the highest available and lowest cost data sources for understanding and characterizing the subsurface rock properties. As such, there is a strong industry need to automatically analyze rock cuttings to reduce human cost, improve the accuracy and efficiency of the analysis process, and shorten the turnaround time of the interpretation.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes receiving, via an analysis and control system, a cutting instance image of a cutting of a geological formation; extracting, via the analysis and control system, a set of cutting features from the cutting instance image, and the set of cutting features corresponds to a feature vector; querying, via the analysis and control system, an index dataset using the feature vector, and the index dataset comprises one or more reference feature vectors; identifying, via the analysis and control system, a number of reference feature vectors from the one or more reference feature vectors, and each of the number of reference feature vectors is associated with a respective reference cutting; determining, via the analysis and control system, a set of cutting properties for the cutting based on the reference cuttings associated with the number of reference feature vectors; and determining, via the analysis and control system, a lithology classification for the cutting based on the set of cutting properties.

Certain embodiments of the present disclosure also include a method that includes extracting, via an analysis and control system, a respective set of reference cutting features from each of one or more reference cutting instance images of a geological formation, and each of the one or more reference cutting instance images is associated with a respective reference cutting, and the respective set of reference cutting features corresponds to a respective reference feature vector; determining, via the analysis and control system, a respective set of reference cutting properties for the respective reference cutting at least based on a guided property description; and indexing, via the analysis and control system, each of the one or more reference cutting instance images with the respective set of reference cutting properties and the respective reference feature vector to generate an index dataset.

Certain embodiments of the present disclosure also include a system that includes a drilling device configured to acquire rock samples from a well, an image acquisition system to obtain an image of the rock samples, and an analysis and control system. The analysis and control system is configured to obtain a cutting instance image for a cutting from the image of the rock samples, extract a set of features from the cutting instance image based on reference data, and determine a lithological classification for the cutting.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates a drilling system, in accordance with embodiments of the present disclosure;

FIG. 2 illustrates a shale shaker removing drill bit cuttings from drilling fluid, in accordance with embodiments of the present disclosure;

FIG. 3 illustrates a drill bit generating cuttings, in accordance with embodiments of the present disclosure;

FIG. 4 illustrates a system that includes an analysis and control system to monitor and control the drilling system of FIG. 1, in accordance with embodiments of the present disclosure;

FIG. 5 illustrates a cuttings collection and image acquisition workflow that may be performed by the analysis and control system of FIG. 4, in accordance with embodiments of the present disclosure;

FIG. 6 illustrates an example workflow for lithological characterization of cuttings based on analysis of images of the cuttings, in accordance with embodiments of the present disclosure;

FIG. 7 illustrates a rock sample image and the corresponding segmented individual cutting instance images, in accordance with embodiments of the present disclosure;

FIG. 8 illustrates other embodiment of the segmented individual cutting instance images of FIG. 7, in accordance with embodiments of the present disclosure;

FIG. 9 illustrates an example workflow for property estimation process of FIG. 6, in accordance with embodiments of the present disclosure;

FIG. 10 illustrates a feature vector space, in accordance with embodiments of the present disclosure;

FIG. 11 illustrates an example of lithology types and the geological hierarchy, in accordance with embodiments of the present disclosure;

FIG. 12 illustrates a user interface used in the workflow of FIG. 9, in accordance with embodiments of the present disclosure;

FIG. 13 illustrates an output display of estimated properties for a rock sample image, in accordance with embodiments of the present disclosure; and

FIG. 14 illustrates a workflow for property propagation/association, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed continuously and/or automatically in substantially real time during operation of the computing system and/or equipment controlled by the computing system, it will be appreciated that these operations may, in fact, be performed continuously and/or automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As described above, whenever a drilling process is involved in an activity, rock cuttings are produced and are generally available at the well site. Cuttings properties may include geological properties observed or measured associated with cuttings. Currently, cuttings are generally under-utilized for the subsurface characterization by geoscientists and reservoir engineers in the oil and gas industry. When these rock cuttings are observed and interpreted by human eyes, it is extremely interpreter-dependent and relatively time consuming as well as physically labor intensive. Accordingly, a need exists for automating the process of cuttings analysis in the industry. To that end, the embodiments described herein provide a domain-based image analysis workflow that includes multiple computational modules to automatically extract relevant geological information from rock cuttings. As used herein, the terms “image”, “digital image”, “photograph”, and “photo” are intended to be used interchangeably. In addition, although described herein as systems and methods for analyzing images of drill bit cuttings, it will be appreciated that the embodiments described herein may be capable of analyzing images of other types of rock particles, such as other types of cuttings, cavings, and so forth as well as non-rock objects in the mud, such as mud additives, metal shavings, and foreign objects.

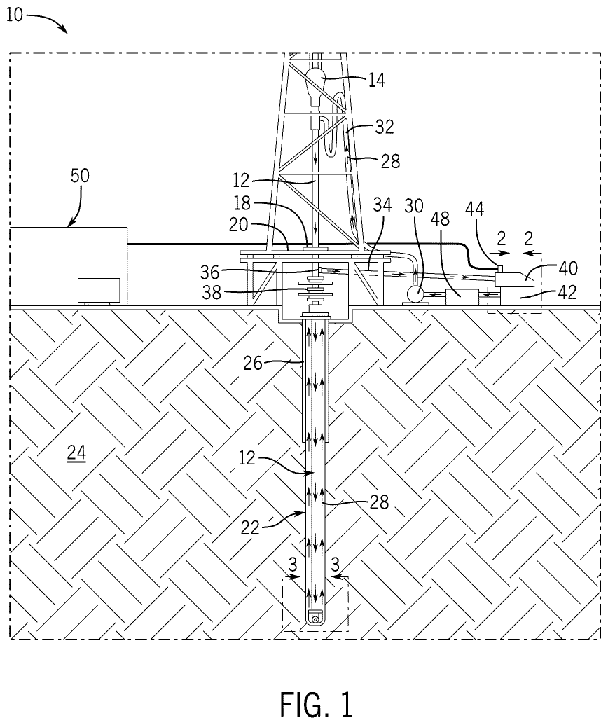

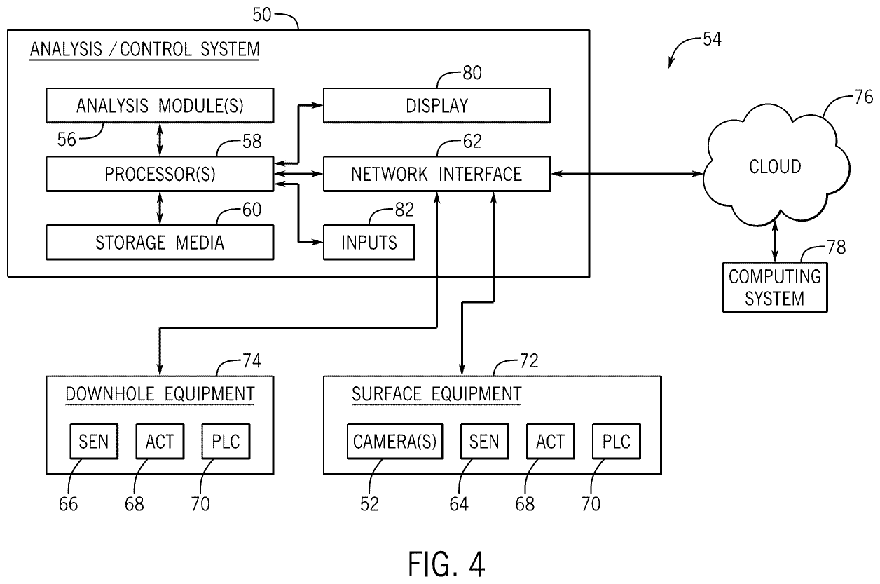

FIG. 1 illustrates a drilling system 10 in accordance with the embodiments described herein. As illustrated, in certain embodiments, a drill string 12 may be suspended at an upper end by a kelly and a traveling block 14 and terminated at a lower end by a drill bit 16 (shown in FIG. 3). The drill string 12 and the drill bit 16 are rotated by a rotary table 18 on a driller floor 20, thereby drilling a borehole 22 into earth formation 24, where a portion of the borehole 22 may be cased by a casing 26. As illustrated, in certain embodiments, drilling fluid or drilling “mud” 28 may be pumped by a mud pump 30 into the upper end of the hollow drill string 12 through a connecting mud line 32. From there, the drilling fluid 28 may be pumped downward through the drill string 12, exiting the drill string 12 through opening in the drill bit 16, and returning to the surface by way of an annulus formed between the wall of the borehole 22 and an outer diameter of the drill string 12. Once at the surface, the drilling fluid 28 may return through a return flow line 34, for example, via a bell nipple 36. As illustrated, in certain embodiments, a blowout preventer 38 may be used to prevent blowouts from occurring in the drilling system 10.

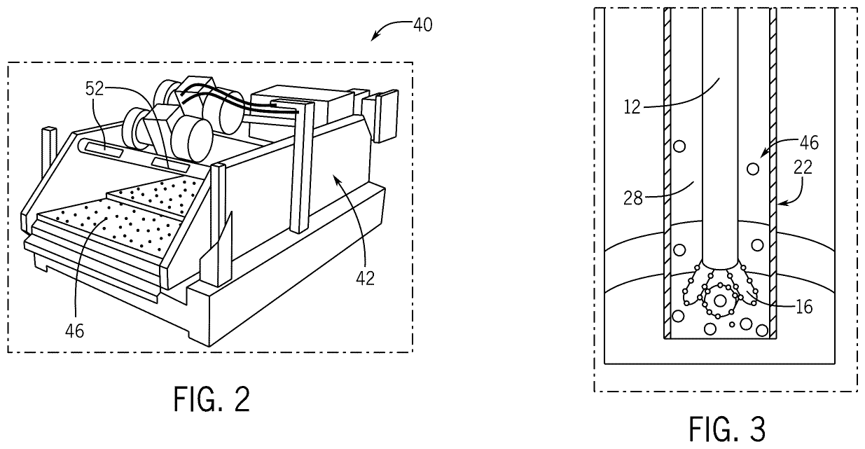

As illustrated in FIG. 1, drill bit cuttings that are formed by the drill bit 16 crushing rocks in the formation 24 may typically be removed from the returned drilling fluid 28 by a shale shaker 40 in the return flow line 34 such that the drilling fluid 28 may be reused for injection, where the shale shaker 40 includes a shaker pit 42 and a gas trap 44. The drilling fluid 28 may then be delivered to a mud pit 48 from which the mud pump 30 may draw the drilling fluid 28. FIG. 2 illustrates drill bit cuttings 46 that have been removed from the drilling fluid 28 in the shaker pit 42 of the shale shaker 40. In FIG. 2, one or more cameras 52 may be used to capture the drill bit cuttings 46. In addition, FIG. 3 illustrates how drill bit cuttings 46 may be created by the drill bit 16, and then flow back up within the drilling fluid 28 through an annulus formed between the wall of the borehole 22 and an outer diameter of the drill string 12.

In addition, as illustrated in FIG. 1, in certain embodiments, an analysis and control system 50 (e.g., a mud logging unit) may be used to control the drilling system 10, as well as provide analysis of the drill bit cuttings 46, as described in greater detail herein. In particular, in certain embodiments, the analysis and control system 50 may be configured to automatically analyze images of the drill bit cuttings 46 that are automatically captured by cameras (e.g., the one or more cameras 52 shown in FIG. 2) during performance of the drilling system 10 illustrated in FIG. 1, as described in greater detail herein. As illustrated in FIG. 2, in certain embodiments, the one or more cameras 52 may be directly associated with (e.g., directly attached to or disposed adjacent to or in close proximity to) the shale shaker 40. However, in other embodiments, the one or more cameras 52 may be other types of cameras not directly associated with the shale shaker 40.

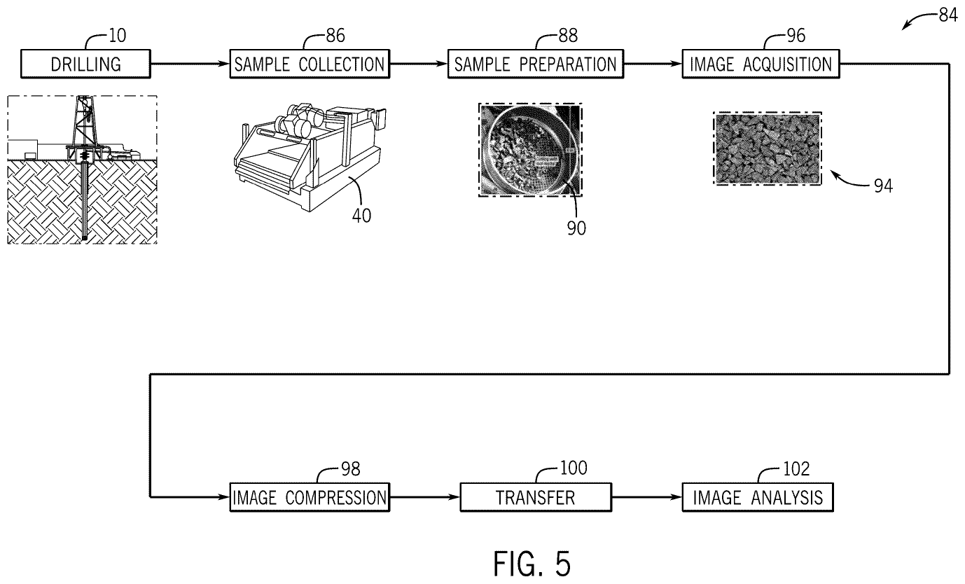

FIG. 4 illustrates a system 54 that includes an analysis and control system 50 to monitor and control the drilling system 10 of FIG. 1, as described in greater detail herein. In certain embodiments, the analysis and control system 50 may include one or more analysis modules 56 (e.g., tools or instruments) that may be configured to perform various functions of the embodiments described herein including, but not limited to, utilizing certain analysis algorithms to analyze images of drill bit cuttings 46 that are captured by the one or more cameras 52, as described in greater detail herein. In certain embodiments, to perform these various functions, an analysis module 56 executes instructions on one or more processors 58 of the analysis and control system 50, which may be connected to one or more storage media 60 of the analysis and control system 50. Indeed, in certain embodiments, the one or more analysis modules 56 may be stored in the one or more storage media 60. In certain embodiments, the one or more analysis modules 56 include analysis hardware (e.g., analysis circuitry) and/or software including processor executable instructions and associated data.

In certain embodiments, the one or more processors 58 may include a microprocessor, a microcontroller, a processor module or subsystem, a programmable integrated circuit, a programmable gate array, a digital signal processor (DSP), or another control or computing device. In certain embodiments, the one or more storage media 60 may be implemented as one or more non-transitory computer-readable or machine-readable storage media. In certain embodiments, the one or more storage media 60 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the processor-executable instructions and associated data of the analysis module(s) 56 may be provided on one computer-readable or machine-readable storage medium of the storage media 60 or, alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 60 may be located either in the machine running the machine-readable instructions, or may be located at a remote site from which machine-readable instructions may be downloaded over a network for execution.

In certain embodiments, the processor(s) 58 may be connected to a network interface 62 of the analysis and control system 50 to allow the analysis and control system 50 to communicate with various surface sensors 64 (Internet of Things (IoT) sensors, gauges, and so forth) and/or downhole sensors 66 described herein, as well as communicate with actuators 68 and/or PLCs 70 of surface equipment 72 and/or of downhole equipment 74 for the purpose of monitoring and/or controlling operation of the drilling system 10, as described in greater detail herein. In addition, in certain embodiments, the network interface 62 may also facilitate the analysis and control system 50 to communicate with one or more cameras 52, as described in greater detail herein. In certain embodiments, the network interface 62 may also facilitate the analysis and control system 50 to communicate data to a cloud-based service 76 (or other wired and/or wireless communication network) to, for example, archive the data or to enable external computing systems 78 (e.g., cloud-based computing systems, in certain embodiments) to access the data and/or to remotely interact with the analysis and control system 50. For example, in certain embodiments, some or all of the analysis modules 56 described in greater detail herein may be executed via cloud and edge deployments.

In certain embodiments, the analysis and control system 50 may include an electronic display 80 configured to display a graphical user interface to present results on the analysis described herein. In addition, in certain embodiments, the graphical user interface may present other information to operators of the equipment 72, 74. For example, the graphical user interface may include a dashboard configured to present visual information to the operators. In certain embodiments, the dashboard may show live (e.g., real-time) data as well as the results of the analysis described herein. In addition, in certain embodiments, the analysis and control system 50 may include one or more input devices 82 configured to enable the operators to, for example, provide commands to the equipment 72, 74 described herein. In addition, in certain embodiments, the display 80 may include a touch screen interface configured to receive inputs from operators.

It should be appreciated that the system 54 illustrated in FIG. 4 is only exemplary, and that the system 54 may have more or fewer components than shown, may combine additional components not depicted in the embodiment of FIG. 4, and/or the system 54 may have a different configuration or arrangement of the components depicted in FIG. 4. In addition, the various components illustrated in FIG. 4 may be implemented in hardware, software, or a combination of both hardware and software, including one or more signal processing and/or application specific integrated circuits. Furthermore, the operations of the system 54 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

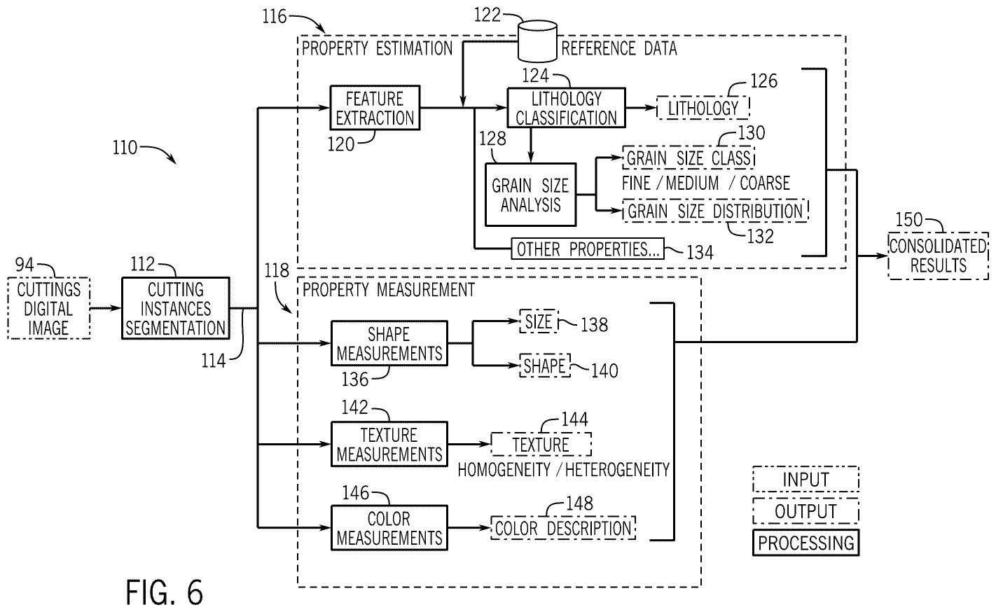

In conventional systems, drill bit cuttings 46 are analyzed by mud loggers in a mud logging unit. These conventional systems are generally human-dependent. The embodiments described herein enhance the analysis of such drill bit cuttings 46. FIG. 5 illustrates a cuttings collection and image acquisition workflow 84 that may be performed by the analysis and control system 50 of FIG. 4. As illustrated in FIG. 5, the cuttings collection and image acquisition workflow 84 begins with a drilling system 10 that generates rock particles (e.g., that include the drill bit cuttings 46 described above). Then, the rock particles are collected, for example, from a shale shaker 40, as described with respect to FIG. 2 (e.g., sample collection 86).

Then, in certain embodiments, the rock particles may be prepared for analysis by, for example, drying the rock particles in an oven for analysis (e.g., sample preparation 88). In addition, in certain embodiments, the sample preparation 88 may include sieving the rock particles using one or more meshes 90 to select cuttings 46 that fall in certain ranges of sizes. In certain embodiments, the sizes of the meshes 90 may be in a range of between 0.25 millimeters (mm) and 3.0 mm and may be approximately 0.25 mm, approximately 0.50 mm, approximately 0.75 mm, approximately 1.0 mm, approximately 1.25 mm, approximately 1.50 mm, approximately 1.75 mm, approximately 2.0 mm, approximately 2.25 mm, approximately 2.50 mm, approximately 2.75 mm, or approximately 3.0 mm. It will be appreciated that consecutive meshes 90 through which the rock particles may be sieved may begin with larger meshes 90 followed by progressively smaller meshes 90 such that larger cuttings 46 are sieved sooner and smaller cuttings 46 are sieved later until such point where the sieved rock particles are so fine that they are no longer considered cuttings 46 per se. It will also be appreciated that the size of a particle cutting 46 is the smallest axis of the cutting 46 when the cutting 46 is approximated as an ellipsoid. In certain embodiments, the sample preparation 88 may include placing the sieved cuttings 46 in a sample tray having a relatively vivid background color (e.g., pure magenta (e.g., with RGB values of 255, 0, 255), pure blue (e.g., with RGB values of 0, 0, 255), pure green (e.g., with RGB values of 0, 255, 0), and so forth). In general, such colors do not exist in nature and, accordingly, help instance segmentation models avoid detecting the background of the sample tray as part of the instance. In certain situations, the sample tray may be prepared by a human or an automated system, so the distribution of the cuttings 46 is often random. For example, the cuttings 46 may be touching or piled in some areas on the sample tray and may be sparsely distributed in other areas.

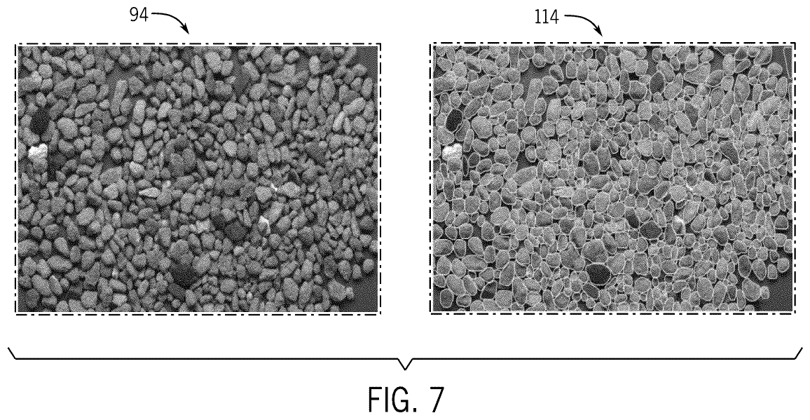

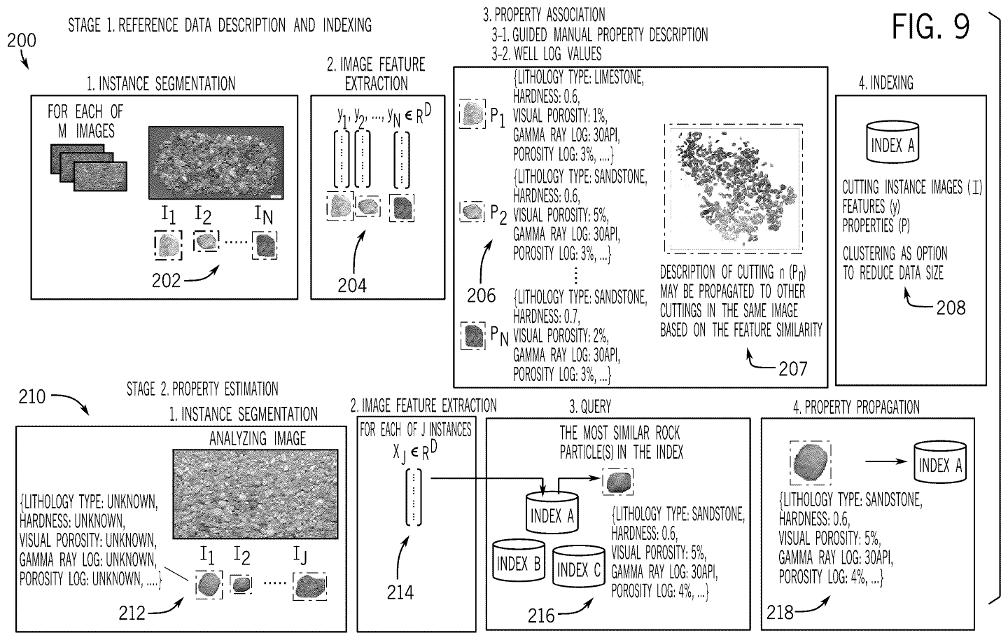

In certain embodiments, an image 94 of the cuttings 46 may be taken (e.g., image acquisition 96) by imaging devices (e.g., the one or more cameras 52). The examples below are given with cameras detecting visible light spectrum, but the same methods may be applied to an image taken with infrared (IR) or ultraviolet (UV) cameras detecting light in UV or IR domains. As described in greater detail herein, in certain embodiments, during the image acquisition 96, illumination, color, and resolution of the image 94 may be calibrated and standardized in order to obtain quantitative and reliable measurements of pixel values between images 94. For example, in certain embodiments, color/illumination calibration may be obtained by using colorimetry algorithms against previously analyzed images 94 and a current image of interest 94, while resolution calibration may be based on lens focal length, focal distance, and sensor size/resolution for the current image 94 of interest as compared to that of previously analyzed images 94. All of these parameters may vary, but the final image is “calibrated” and the same objects may be digitalized with reasonably near values. Pixel values (e.g., the images 94 may be digital images) and size are, therefore, treated as effective measurements of the particle rather than mere representation. The embodiments described herein enable the creation of such calibrated and error-assessed input images 94. Without such calibration, final object classification may vary because of the acquisition rather than because of any real-world difference. In certain embodiments, an optical image of the sample under the visible light may be taken. In certain embodiments, an optical image of the same sample under the UV light, which may cause the fluorescence of some minerals and oil (if oil is trapped in the cuttings), may be taken. This may be a clue for certain rock types or existence of oil in the geological formation which the cutting belonged to. In certain embodiments, the optical images of the same sample taken under different light spectrum (e.g., visible light, UV, IR) may be combined for image analysis of the sample, as described in FIG. 6 and FIG. 8.

Then, in certain embodiments, the image 94 (e.g., digital image) of the cuttings 46 may be compressed for easier transfer (e.g., image compression 98). In particular, well sites are quite often in relatively remote locations where the available network bandwidth may be relatively slow. Accordingly, compressing the images 94 of cuttings 46 may facilitate transfer of the images 94. It will be appreciated that compressing the images 94 of cuttings 46 may not be as beneficial if there is higher bandwidth at the well site (e.g., when the well site has cable internet access). Then, in certain embodiments, the image 94 of the cuttings 46 may be transferred (e.g., image transfer 100), for example, to the analysis and control system 50 and/or the computing system 78 illustrated in FIG. 4 for analysis, as described in greater detail herein. The analysis and control system 50 may be at the well site or in a remote location. Then, in certain embodiments, analysis of the image 94 of the cuttings 46 (e.g., image analysis 102) may include extraction of geologically meaningful information relating to the cuttings 46 from the image 94, as described in greater detail herein.

The embodiments described herein determine measurements from images 94 of cuttings 46 that relate to lithology of the formation 24 from which the cuttings 46 are generated based on lithology geological scientific definitions. In general, the lithology of a rock unit is a description of its physical characteristics visible at an outcropping, in hand or core samples, or with low magnification microscopy. Such physical characteristics include, but are not limited to, color, texture, grain size, and composition. Lithology may refer to either a detailed description of these physical characteristics, or a summary of the gross physical character of a rock. Examples of lithology types may include sandstone, slate, basalt, limestone, and so forth. As such, color, texture, and grain size are physical characteristics of a type of lithology, and the workflows described herein illustrate how these physical characteristics may be measured, extracted, and consolidated to obtain automated lithological image recognition.

The embodiments described herein apply to analysis of calibrated images 94 of prepared cuttings 46, regardless of the particular methods used to achieve the sample preparation 88, the image acquisition 96, the image compression 98, and the image transfer 100, described with respect to FIG. 5.

In certain embodiments, the analysis and control system 50 may be configured to separate pixels of individual rock particles from multiple particles (e.g., cuttings 46) depicted in an image 94 (e.g., calibrated image). In addition, in certain embodiments, the analysis and control system 50 is configured to determine relevant morphological (e.g., size, shape, and so forth), color, and texture data from one or more individual rock particles (e.g., cuttings 46) depicted in a calibrated image 94. In addition, in certain embodiments, the analysis and control system 50 may be configured to utilize extracted information from calibrated images 94 to perform geological/lithological classification at a plurality of different hierarchical levels (e.g., at a single particle/cutting level, at a single sample level of a plurality of cuttings, at a particular depth interval within a borehole 22, for a particular geological formation 24, for an entire well, for an entire well field, and so forth). As described in greater detail herein, consolidating the analysis results in a plurality of hierarchical levels enables operators to analyze the cuttings 46 in a much more robust (and automated and more accurate) manner than conventional techniques. In addition, in certain embodiments, the analysis and control system 50 may be configured to utilize the information derived herein based on the calibrated images 94 to create a mud logging report. In addition, in certain embodiments, the analysis and control system 50 may be configured to output from the calibrated images 94 any relevant information that can be integrated with other well-related answer products. In addition, in certain embodiments, the analysis and control system 50 may be configured to utilize a supervised machine learning model (e.g., from another well in the same field or another field with similar geological setting) to infer the lithology type from a calibrated image 94 from the current well. In addition, in certain embodiments, the analysis and control system 50 may be configured to utilize all of this type of information to automatically adjust operating parameters of a drilling system 10 (e.g., drilling fluid composition, drill bit speed, and so forth), as described in greater detail herein.

While the cuttings collection and image acquisition workflow 84 illustrated in FIG. 5 has been described with particular reference to analyzing cuttings 46 to determine geologically meaningful information relating to the cuttings 46 from images 94, the embodiments described herein may be extended to the analysis of images 94 to identify features of other types of objects, rather than just cuttings 46.

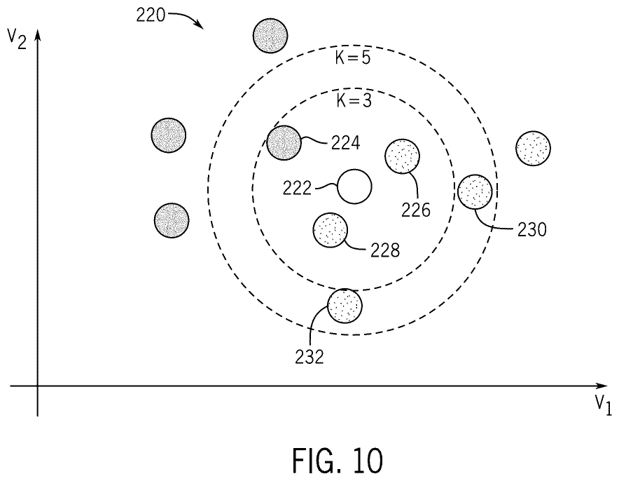

In certain embodiments, object-based image analysis (OBIA) may be used to analyze the images 94 (e.g., calibrated images). OBIA generally involves grouping a number of pixels in a digital image into shapes with a meaningful representation of objects based on either spectral or spatial similarity or an external variable (e.g., soil or geological unit). OBIA may be used to address complex classes that are defined by spatial and hierarchical relationships within and during the classification process, as illustrated in FIG. 9. OBIA may include image segmentation, feature extraction, and classification, as illustrated in FIG. 6. As mentioned previously, calibrated images 94 may be used in the image analysis to obtain more reliable results. The embodiments described herein focus on feature extraction and classification analysis of calibrated images 94. Certain embodiments implement lithological recognition and/or classification from images 94 of cuttings 46 by applying neural network (NN) and machine learning (ML) techniques.

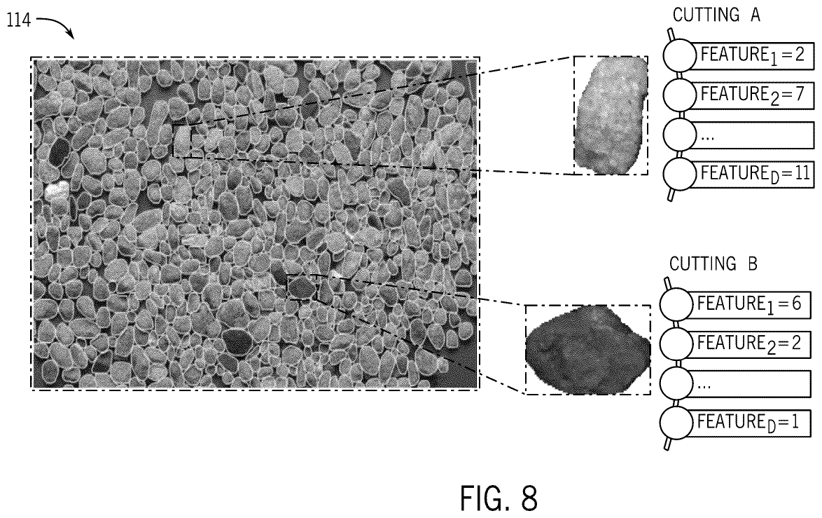

FIG. 6 illustrates an example workflow 110 of the object-based image analysis (OBIA) for an image 94 (e.g. calibrated image) by the system 54. The image 94 (e.g., digital image) may be input into a cutting instances segmentation module 112 (e.g., tools or instruments) of the system 54 to obtain segmented individual cutting instance images 114 (shown in FIG. 7). The cutting instances segmentation module 112 may identify and separate individual objects within the calibrated image 94, for example, by detecting the boundaries of each object and assigning a unique label to each object, as illustrated in FIG. 7 and FIG. 8. FIG. 7 shows an example of a calibrated image 94 and the corresponding segmented individual cutting instance images 114. In certain embodiments, the cutting instances segmentation module 112 may include analysis hardware (e.g., analysis circuitry) and/or software including processor executable instructions and associated data. In certain embodiments, the cutting instances segmentation module 112 may utilize Mask R-CNN (Region-based Convolutional Neural Networks) to identify various objects in the calibrated image 94, which has been found to outperform conventional segmentation methods. A Mask R-CNN model is trained in a supervised manner, and it has been found that the same approach may be taken to efficiently build a system to run the instance segmentation using any type of image (e.g., digital image, distance image, etc.) and rock particle scene (e.g., cuttings, mining site, space, etc.) by training the model with relevant datasets.

The segmented individual cutting instance images 114 may be used in a rock property estimation process 116 and a rock property measurement process 118. For instance, in the rock property estimation process 116, the segmented individual cutting instance images 114 may be input into a feature extraction module 120 (e.g., tools or instruments) of the analysis and control system 50. In certain embodiments, the feature extraction module 120 may include analysis hardware (e.g., analysis circuitry) and/or software including processor executable instructions and associated data The feature extraction module 120 may analyze the segmented individual cutting instance images 114 using reference data 122 (e.g., baseline cuttings used for reference) and output a set of parameters (features) representing the color and textural properties of the cutting instance, which may be key visual properties to identify rock types, as illustrated in FIG. 8. Thus, cutting features are a set of values that represent or summarize color and texture information of a cutting instance image. FIG. 8 shows an example of the segmented individual cutting instance images 114 with individual cutting instance images (e.g., cutting A and cutting B) indicated with corresponding set of parameters for number D of features (e.g., feature₁, feature₂ . . . feature_{D}). As illustrated in FIG. 8, the individual cutting instance images (e.g., cutting A, cutting B) in the segmented individual cutting instance images 114 may have arbitrary sizes, shapes (e.g., height (H), width (W)), and colors. The feature extraction module 120 may analyze the segmented individual cutting instance images 114, and each cutting instance image (Ii) may be transformed from the image space, Iᵢ ∈R^{(H}^{ᵢ}^{×W}^{ᵢ}^{×3)} (e.g., height (Hi), width (Wi), 3 color channels (e.g., red, green, blue)), to a D-dimensional feature vector space, [symbol] ∈R^{D}. The D-dimensional feature vector space R^{D} may include number D of feature (e.g., feature₁, feature₂ . . . feature_{D}) axes, and the feature vector [symbol] may have a set of parameters along respective feature axes in the feature vector space R^{D}. In certain embodiments, different types of images representing different physical properties of the same rock particle samples may be obtained without changing the position of the samples in the sample tray. In such cases, we may combine those images and generate a single multi-channel image. Thus, the transformation is from the image space Iᵢ∈R^{(H}^{ᵢ}^{×W}^{ᵢ}^{×C)}, where C is the number of channels (e.g., physical properties of the rock particle samples, such as colors), to a D-dimensional feature vector space [symbol] ∈R^{D}. For example, in certain embodiments, fluorescence of the minerals in the cuttings may be a clue for certain rock types, and an optical image of the same sample (e.g., cuttings 46) under the UV light, which may cause the fluorescence of the minerals, may be combined with the calibrated image 94 (e.g., obtained using visible light) to create a 6 channel image (e.g., 3 color channels for the image taken with UV light and 3 color channels for the image taken with visible light). In this case, the transformation will be from an image space Iᵢ∈R^{(H}^{ᵢ}^{×W}^{ᵢ}^{×6)} to the D-dimensional feature vector space, [symbol] ∈R^{D}. The feature vectors of the segmented individual cutting instance images 114 may be used by a lithology classification module 124 (e.g., tools or instruments) of the analysis and control system 50 to determine the lithology 126 of the cuttings 46, as described in greater detail herein. In certain embodiments, the lithology classification module 124 may include analysis hardware (e.g., analysis circuitry) and/or software including processor executable instructions and associated data. For a lithology type of rock (e.g., sandstone), a grain size analysis module 128 (e.g., tools or instruments) of the analysis and control system 50 may be used to analyze each individual cutting 46 to identify a grain size class (e.g., fine, medium, coarse, and so forth) 130 and a grain size distribution 132, among other grain size-related properties, of each individual cutting 46. In certain embodiments, the grain size analysis module 128 may include analysis hardware (e.g., analysis circuitry) and/or software including processor executable instructions and associated data.

The feature vectors of the segmented individual cutting instance images 114 may be used with other properties 134 (e.g., properties not easily extracted from digital images) to estimate rock properties, as described in greater detail herein. For example, other properties 134 may include guided manual property descriptions, associated well log values, or other external data such as, but not limited to, stratigraphic geological sequences, while-drilling logs, 3D model properties, cutting physical analysis (e.g., diffractometry, calcimetry, acid test), or any other information that may be useful to resolve lithology classification ambiguities. In certain embodiments, the other properties 134 may be determined by using instruments/tools (e.g., surface equipment 72, downhole equipment 74), analysis hardware (e.g., analysis circuitry), and/or software including processor executable instructions and associated data.

As illustrated in FIG. 8, the individual cutting instance images (e.g., cutting A, cutting B) in the segmented individual cutting instance images 114 may have arbitrary sizes, shapes, and colors. The property measurement process 118 may use a shape measurements module 136 (e.g., tools or instruments) of the analysis and control system 50, and the segmented individual cutting instance images 114 may be analyzed by the shape measurement module 136 based on individual instances to determine the size 138 and shape 140 of the individual instances. The property measurement process 118 may use a texture measurements module 142 (e.g., tools or instruments) of the analysis and control system 50, and the segmented individual cutting instance images 114 may be analyzed by the texture measurement module 142 based on individual instances to determine the texture 144 of the individual instances, such as homogeneous, heterogeneous, laminated, grainy, and so forth. The property measurement process 118 may also use a color measurements module 146 (e.g., tools or instruments) of the analysis and control system 50, and the segmented individual cutting instance images 114 may be analyzed by the color measurement module 146 based on individual instances to determine the color 148 of the individual instances. In certain embodiments, the shape measurements module 136, the texture measurement module 142, and the color measurements module 146 may include analysis hardware (e.g., analysis circuitry) and/or software including processor executable instructions and associated data. The outputs of the property estimation process 116 (e.g., the lithology 126, the grain size class 130, the gran size distribution 132) and the outputs of the property measurement process 118 may be combined to obtain consolidated results 150.

The property estimation process 116 may include two stages: stage one for reference data description and indexing (e.g., for baseline cuttings used for reference); and stage two for property estimation of a cutting instance image based on the reference data description and indexing obtained in stage one. FIG. 9 shows a workflow 200 of stage one for using the reference data 122 for data description and indexing. In some embodiments, the workflow 200 may include instruments/tools (e.g., surface equipment 72, downhole equipment 74), hardware (e.g., analysis circuitry), and/or software including processor executable instructions and associated data. The reference data 122 may include image data for a set of M images (e.g., calibrated images 94) obtained when analyzing previous wells or previous data of the current well.

The workflow 200 may include instance segmentation (process 1), image feature extraction (process 2), property association (process 3), and indexing (process 4). In process 1 of the workflow 200, each image of the set of M images may be analyzed (e.g., by the cutting instances segmentation module 112) to obtain respective segmented individual cutting instance images 201 having a number (e.g., N) of individual cutting instance images 202 (e.g., I₁, I₂, . . . I_{N}). The cuttings in the individual cutting instance images 202 (e.g., I₁, I₂, . . . I_{N}) may be used as reference cuttings or baseline cuttings. In process 2 of the workflow 200, the segmented individual cutting instance images may be analyzed (e.g., by the feature extraction module 120) to obtain corresponding set of parameters for number D of features (e.g., feature₁, feature₂ . . . feature_{D}) for the individual cutting instance images 202 (e.g., I₁, I₂, . . . I_{N}). Thus, the individual cutting instance images 202 (e.g., I₁, I₂, . . . I_{N}) may be transformed from the image space to corresponding feature vectors 204 (e.g., represented by corresponding matrix y₁, y₂, . . . y_{N}) in the D-dimensional feature vector space R^{D}.

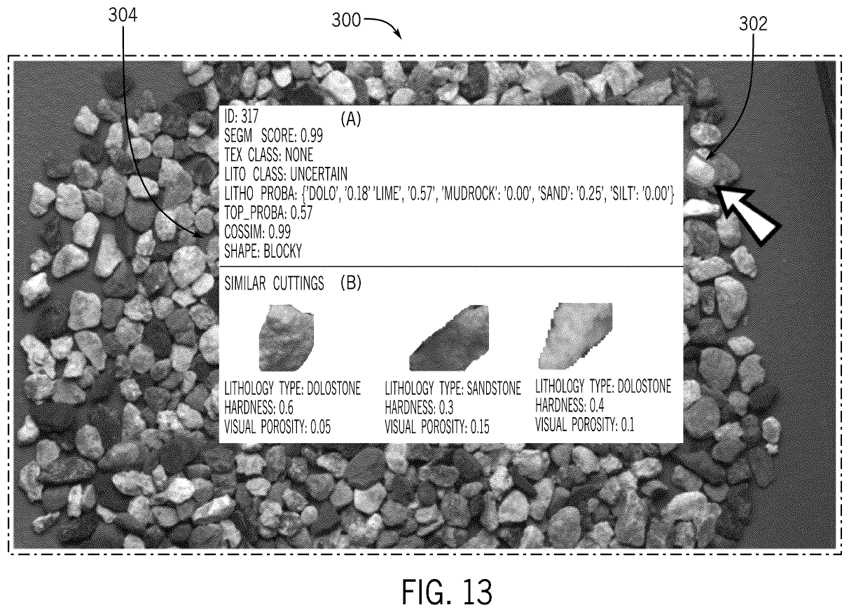

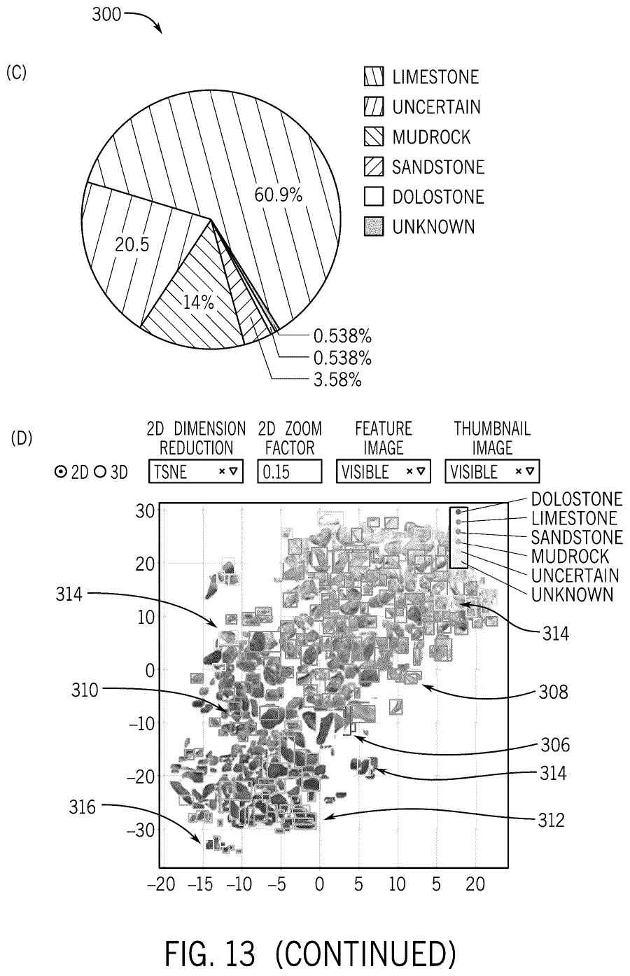

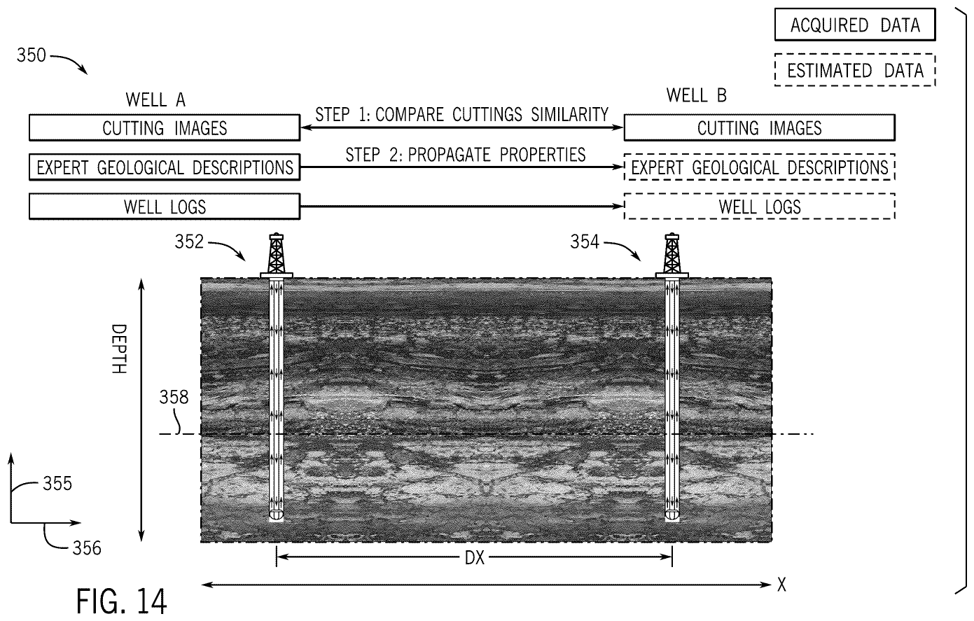

In process 3 of the workflow 200, the individual cutting instance images 202 (e.g., I₁, I₂, . . . I_{N}) may be manually described by geologists (e.g., 3-1 guided manual property description) who is guided by a cutting description software, which is described in detail in FIGS. 12 and 13. The cutting description software may include a description wizard having multiple entries, such as lithology type, hardness, visual porosity, etc. Some of the entries of the description wizard may not be easily extracted from digital images. In process 3 of the workflow 200, well log values may also be used for property description (e.g., 3-2 Well log values association). Well log may include a detailed record for the geologic formation (e.g., the formation 24). The detailed record may include information regarding the geologic properties (e.g., lithology, layer, depositional environments) and petrophysical characterization (e.g., water saturation, porosity, permeability, volume of shale) of the geologic formation, which may be used to control the drilling device or a drilling plan of the drilling system 10. Well log may be a function of the borehole depth. For example, cuttings 46 may be collected at a depth of the borehole 22, and the well log value at the depth may be associated with the cuttings from the same depth of the same well or different wells, as illustrated in FIG. 14. This approach may be used, for example, when the reference data of stage one includes a well with cuttings and well log measurements, and the cutting instance image in stage two includes another well with cuttings but without well log measurements. A property 206 (e.g., P₁, P₂, . . . P_{N}) of the corresponding individual cutting instance images 202 (e.g., I₁, I₂, . . . I_{N}) may be determined by using the guided manual property description, associated well log values, or other external data such as, but not limited to, stratigraphic geological sequences, while-drilling logs, 3D model properties, cutting physical analysis (e.g., diffractometry, calcimetry, acid test), or any other information that may be useful to resolve lithology classification ambiguities. The property 206 may include properties of the reference cuttings in the individual cutting instance images 202, such as lithology type, hardness, visual porosity, gamma ray log, porosity log, etc. For example, P₁ may include a description “Lithology type: Limestone; Hardness:0.6, Visual porosity: 1%, Gamma Ray log: 30API; Porosity log: 3% . . . .” P₂ may include a description “Lithology type: Sandstone; Hardness:0.6, Visual porosity: 5%, Gamma Ray log: 30API; Porosity log: 3% . . . .” P_{N} may include a description “Lithology type: Sandstone; Hardness:0.7, Visual porosity: 2%, Gamma Ray log: 30API; Porosity log: 3% . . . .” The property description of the Nth reference cutting (P_{N}) may be propagated to other cuttings in the same segmented individual cutting instance images based on the feature similarity, and a view 207 (e.g., two-dimensional (2D) view, three-dimensional (3D) view) of the property description of the cuttings may be displayed on a user interface.

In process 4 of the workflow 200, the cutting instance images (e.g., I₁, I₂, . . . I_{N}), the feature vectors 204 (e.g., represented by corresponding matrix y₁, y₂, . . . y_{N}), and the corresponding property 206 may be indexed and stored together in an index dataset 208 (e.g., index A). The index dataset 208 may contain the cutting instance images (e.g., I₁, I₂, . . . I_{N}), the feature vectors 204 (e.g., represented by corresponding matrix y₁, y₂, . . . y_{N}), and the corresponding property 206 (e.g., P₁, P₂, . . . P_{N}) for the set of M images in the reference data 122. In process 4, a clustering technique may be applied to the index dataset 208 to reduce the data size of the index. The clustering technique may be a data compression technique or redundancy reduction technique. For example, when there are multiple cutting instances that are visually very similar and corresponding feature distances (e.g., the squared Euclidean (L2-squared) distance) in the feature vector space R^{D} are very close to each other, the cutting instances may be grouped into a cluster and only the representative cutting instance may be retained, wherein the representative cutting instance may be the centroid cutting instance of the cluster. Multiple index databases may be created by using different sets of M images. For example, various index datasets (e.g., index A, index B, index C) may be created from images of specific geographical locations or specific geological formations.

FIG. 9 also shows a workflow 210 for property estimation (e.g., lithology type, hardness, visual porosity, Gamma ray log, porosity log) of a cutting instance image using the property 206 and the index dataset 208 obtained in the workflow 200. In some embodiments, the workflow 210 may include instruments/tools (e.g., surface equipment 72, downhole equipment 74), hardware (e.g., analysis circuitry), and/or software including processor executable instructions and associated data. The workflow 210 may include instance segmentation (process 1), image feature extraction (process 2), query (process 3), and property propagation (process 4). In process 1 of the workflow 210, an image (e.g., a calibrated image 94) may be analyzed (e.g., by the cutting instances segmentation module 112) to obtain segmented individual cutting instance images having a number (e.g., J) of unknown individual cutting instance images 212 (e.g., I₁, I₂, . . . Iⱼ) (e.g., unknown lithology type, unknown hardness, unknown visual porosity, unknown Gamma ray log, unknown porosity log). In process 2 of the workflow 210, the segmented individual cutting instance images may be analyzed (e.g., by the feature extraction module 120) to obtain a set of parameters for number D of features (e.g., feature₁, feature₂ . . . feature_{D}) for each of the unknown individual cutting instance images 212 (e.g., I₁, I₂, . . . I_{J}). Thus, each of the unknown individual cutting instance images 212 (e.g., I₁, I₂, . . . I_{J}). may be transformed from the image space to corresponding feature vectors 214 (e.g., represented by corresponding matrix x_{J}) in the D-dimensional feature vector space R^{D}. The process 1 and process 2 of the workflow 210 may be repeated for the new images acquired.

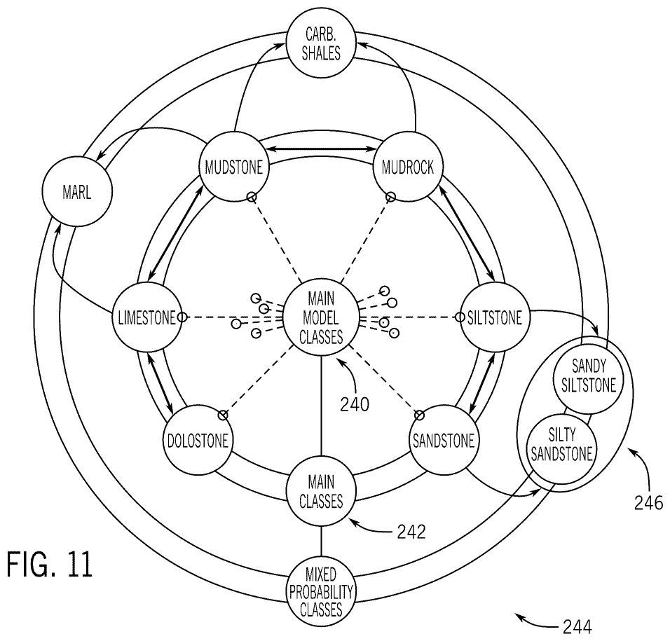

The process 3 of the workflow 210 may be used to retrieve a number K of most similar (K≥1) cuttings 216 from the index storage (e.g., index A, index B, index C) for each of the unknown individual cutting instance images 212 (e.g., I₁, I₂, . . . I_{J}) by comparing the feature vector 214 (e.g., represented by corresponding matrix xi) with feature vectors (e.g., represented by corresponding matrix y₁, y₂, . . . y_{N}) of the index storage. As described above, the properties (e.g., lithology type, hardness, visual porosity, Gamma ray log, porosity log) of the number K of most similar cuttings 216 may be obtained in the property association of stage one. Distances (e.g., the squared Euclidean (L2-squared) distance) in the feature vector space R^{D} between the feature vector 214 (e.g., represented by corresponding matrix x_{J}) and the feature vectors (e.g., represented by corresponding matrix y₁, y₂, . . . y_{N}) of the index storage may be calculated, and the nearest neighbor search method may be used to determine the number K of most similar cuttings 216 by finding the number K of smallest distances, as illustrated in FIG. 10.

FIG. 10 is a schematic plot showing a D-dimensional feature vector space R^{D} 220 (e.g., D=2 with two features V1 and V2). Distances dᵢ(e.g., i=1, 2 . . . N) (e.g., the squared Euclidean distance (L2-squared)) in the feature vector space R^{D} 220 between a feature vector of a cutting instance image 222 (e.g., represented by corresponding matrix x_{J}) and feature vectors (e.g., represented by corresponding matrix y₁, y₂, . . . y_{N}) of the index storage may be calculated, and the nearest neighbor search method may be used to determine the number K (e.g., K=1, 2,3 . . . ) of most similar rock particles. For example, in FIG. 10, when K=3, feature vectors of cutting instance images 224, 226, and 228 (e.g., cutting instance images 224 and 226 may be of a first class of rock properties while cutting instance image 228 may be of a second class of rock properties) may have the nearest distances to the feature vector of the cutting instance image 222 in the feature vector space R^{D}, and the rock particles corresponding to the cutting instance images 224, 226, and 228 may be used for the property description of the cutting instance image 222. When K=5, additional two feature vectors of cutting instance images 230 and 232 may be included and used for the property description of the cutting instance image 222. For example, categorical properties of the rock particles corresponding to the cutting instance image 222 may be determined based on the ratio

$$( {p}_{c l a s s} = \frac{{K}_{c l a s s}}{K} )$$

of the number of respective class of rock particles (K_{class}) included in the K determined most similar cuttings, as described in details in FIG. 9. For example, in the example describe above when K=3, the ratio of the first class ρ₁ (cutting instance images 224 and 226) of rock particles is while the ratio of the second class ρ₂ (cutting instance images 228) of rock particles is 3. When the index dataset is not sufficiently large or not sufficiently diverse, a warning may be sent out to notify the user. It should be noted that, although a two-dimensional feature vector space is used in FIG. 10, the feature vector space R^{D} may be of any dimension (e.g., D=1, 10, 50, . . . ).

In some embodiments, for each determined feature vector yₖ (k=1, 2 . . . K), a respective score may be obtained by inverting the distance

$${s}_{k} = \frac{1}{{d}_{k}} ,$$

and a weight

$${w}_{k} = \frac{{s}_{k}}{{\sum }_{k = 1}^{K} {s}_{k}}$$

may be determined, which is a normalized score. Thus, a smaller distance dₖ corresponds to a greater score and a greater weight, which corresponds to a higher probability of corresponding cuttings. For example, a weight set of (sandstone, siltstone, shale, dolostone, limestone) is (0.9, 0.0, 0.0, 0.1, 0.0), which indicates the weights (probabilities) of sandstone, siltstone, shale, dolostone, and limestone are 0.9, 0.0, 0.0, 0.1, and 0.0, respectively. Categorical properties of the samples may be determined by using the weights (probabilities) to select the most probable category.

Referring back to FIG. 9, in the process 4 of the workflow 210, a corresponding property description 218 (e.g., lithology type, hardness, visual porosity, Gamma ray log, porosity log) may be determined for each of the unknown individual cutting instance images 212 (e.g., I₁, I₂, . . . I_{J}) by using the K most similar rock particles 216. For instance, index dataset in the index storage might be selected to have a better accuracy of query and thus the property estimation. For example, in FIG. 9, the index dataset A may be selected among other options such as index dataset B and index dataset C based on geographical locations, geological formations, well locations, depths in a well, etc. A workflow of property propagation is illustrated in FIG. 14. When K equals to 1, the properties of the retrieved cutting 216 may be simply copied to the unknown individual cutting instance image 212 being analyzed, as illustrated in FIG. 9. For example, when K equals to 1, the most similar rock particle in the index may have the property description as ““Lithology type: Sandstone; Hardness:0.6, Visual porosity: 5%, Gamma Ray log: 30API; Porosity log: 4% . . . ,” and the unknown individual cutting instance image 212 being analyzed may be determined to have the same property description. When K is greater than 1, the properties of the retrieved cuttings 216 may be summarized and copied to the unknown individual cutting instance image 212 being analyzed using various ways. For example, for categorical property (such as Lithology class), the probability may be calculated for each class and the most probable category may be selected. To calculate the probability for each class, a ration

$${p}_{class} = \frac{{K}_{c l a s s}}{K}$$

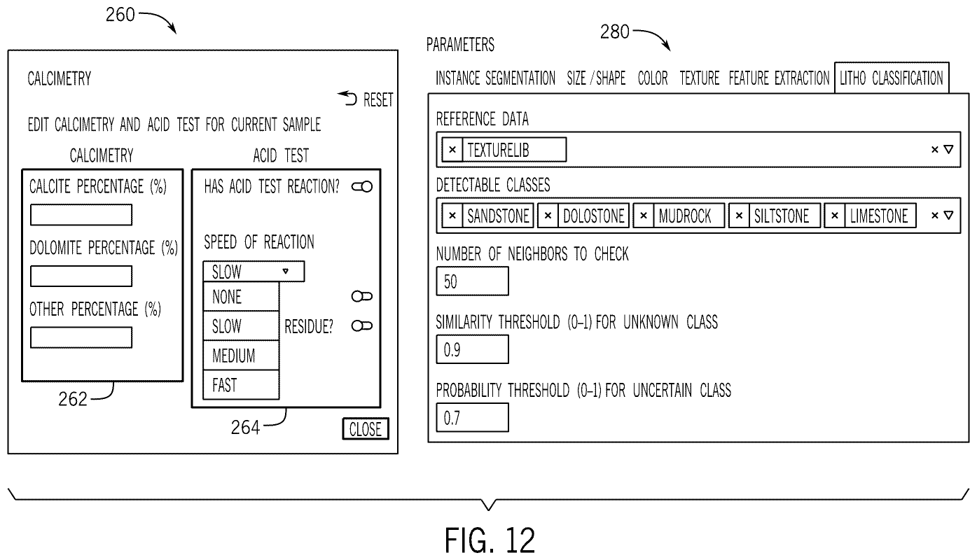

may be used, where the K_{class} is the number of the respective class included in the number K of most similar cuttings 216. For example, in the example describe above in FIG. 10, when K=3, the ratio of the first class ρ₁ (cutting instance images 224 and 226) of rock particles is ⅔ while the ratio of the second class ρ₂ (cutting instance images 228) of rock particles is ⅓. In some embodiments, a sum of the weights (wⱼ) of the feature vectors (yⱼ) in the target class may be used. For example, in the above example, the weights of the two feature vectors corresponding to cutting instance images 224 and 226 may be calculated as described above in FIG. 10, and a sum of them may be used for the probability of the first class; and the weight of the feature vector corresponding to cutting instance images 228 may also be calculated and used for probability of the second class. By using the sum of the weights of the feature vectors, the probabilities of each class may be determined more accurately. For example, in case of lithology type, if the probability of (sandstone, siltstone, shale, dolostone, limestone) is (0.9, 0.0, 0.0, 0.1, 0.0), sandstone (probability of 0.9) may be assigned to the unknown individual cutting instance image 212 being analyzed. Regarding the lithology type in particular, a sub-category may be created based on the geological hierarchy, as illustrated in FIG. 11.

FIG. 11 is a diagram showing an example of lithology types and the geological hierarchy. For instance, the lithology types may include main model classes 240, main classes 242 (e.g., sandstone, siltstone, mudrock, mudstone, limestone, dolostone), and mixed probability classes 244 (e.g., marl, carb. shales). A sub-category 236 may be created if more than one lithology types have probabilities greater than a threshold (e.g., 0.3). For example, when the probability of (sandstone, siltstone, shale, dolostone, limestone) is (0.6, 0.4, 0.0, 0.0, 0.0), instead of simply assigning “sandstone”, “silty sandstone” 246 may be assigned to the unknown individual cutting instance image 212 being analyzed since both the sandstone and the siltstone have probabilities greater than the threshold. Similarly, “sandy siltstone” 246 may be assigned to the unknown individual cutting instance image 212 being analyzed when a probability of (sandstone, siltstone, shale, dolostone, limestone) is (0.4, 0.6, 0.0, 0.0, 0.0). In addition, the grain size property may also be considered when assigning the lithology name. For example, instead of assigning “sandstone”, “very fine sandstone” may be used to indicate the grain size. Therefore, the manually described cuttings may have fixed properties from manual descriptions, while the one that gets the propagated properties may have an enhanced or adjusted property assignment. In case of numerical property (such as visual porosity), the average or weighted average (e.g., weight wⱼ of yⱼ that is in the target class) of the property of the number K of most similar cuttings 216 may be used. The analyzed cutting instance image, features, and cutting properties may be added to the index dataset to be used for next query. For example, lithology may vary continuously in the geologic formation, and cuttings at a certain depth of a well may be associated with the cuttings from the same depth of the same well or different wells. Therefore, the cutting properties of the analyzed cutting instance image may be associated with the cutting properties of other cuttings obtained from the same depth of the same well or different wells, as illustrated in FIG. 14.

FIG. 12 shows a user interface (UI) 260 of the software displayed on the electronic display 80 for external information of calcimetry and acid test, and a user interface 280 having multiple parameters to make query and estimation result more accurate. For example, the user may select the reference data for the best accuracy of the query. The reference data may be obtained from the analysis of an adjacent well or well from similar formation in another location. The detectable lithology classes may be used to constrain the query based on the lithology type. In many cases, the user may have a clue, through external information, of what lithology type may or may not be detected on the analyzing image. The external information, such as (1) calcimetry of the same cutting samples, (2) acid test of the same cutting samples, (3) image under the UV light of the same cutting samples, (4) local geological context, and (5) well logs, etc. The process of adding constraints may be done manually by the user or automatically by the system 54. For instance, calcimetry gives the percentage 262 of (a) calcite, (b) dolomite, and (c) Other minerals. For example, if the percentage of other minerals is greater than a threshold (e.g., 90%), carbonate (calcite and dolomite) may be removed from detectable class. On the other hand, if the percentage of other minerals is greater than a threshold (e.g., 10%), sandstone may be removed from detectable class. The acid test may include dropping acid liquid on individual cutting and observing the chemical reaction. The acid test 264 may be used to distinguish between carbonate (limestone, dolostone) and clastics (sandstone, siltstone) since carbonate minerals (calcite, dolomite) react with acid. This information may be used to validate or correct the lithology estimation obtained in the process 116. The acid test result may be assigned to the lithology estimation for each individual instance in the process 116.

The parameter of number of neighbors to check corresponds to the value K described above. This value would have certain impacts on the result of the query. The default value will be provided, but users might change this parameter. The parameter of similarity threshold for unknown class is another way to constrain the query based on the lithology type. When there are no similar cuttings in the index reference dataset to the analyzing cutting, “unknown” category may be assigned to the analyzed cutting. The similarity may be defined as the Euclidean distance or cosine distance between the feature vector of the analyzed cutting and the feature vectors of the cuttings in the reference dataset. For example, when the Euclidean distances between the feature vector of the analyzed cutting and the feature vectors of the cuttings in the reference dataset are less than the similarity threshold, the analysis and control system 50 may determine that no similar cuttings in the index reference dataset and “unknown” category may be assigned to the analyzed cutting. The probability threshold for an uncertain class is another way to constrain the query based on the lithology type. When K>1, the output lithology type may be expressed as probability of each category. “Uncertain” category may be assigned to the cutting properties, when there is no distinct lithology class so that the probabilities of possible lithology classes are all less than a first threshold (e.g., 0.4). For example, when the probability of (sandstone, siltstone, shale, dolostone, limestone) is (0.9, 0.0, 0.0, 0.1, 0.0), the sandstone may be selected since it is dominated. When it is (0.3, 0.3, 0.2, 0.1, 0.1), “Uncertain” category may be output since there is not a dominated class that has a probability greater than a second threshold (e.g., 0.4). The threshold may be controlled by the user or automatically by the system 54 to reduce false positive ratio.

FIG. 13 shows an output display of estimated properties for an image 300 of rock samples. It should be noted that the computed properties may be displayed on the user interface 260 in a variety of ways, and the embodiment illustrated in FIG. 13 is an example. For example, the corresponding information may be displayed when the user hovers over or select (e.g., using a mouse or touch screen) a cutting 302 (e.g., property information (A) and most similar cuttings and corresponding properties (B) in a window 304). In addition, the lithology percentage of the image 300 may be displayed (e.g., in (C)) and cutting images projected in the 2D or 3D space after reducing the dimension from the original D-dimensional feature space using projection techniques such as t-SNE (t-distributed stochastic neighbor embedding) or PCA (principal component analysis) may also be displayed. The color and patterns used in the percentage may be lithological patterns of the user company's standard or based on the USGS (United States Geological Survey) standard. The property description of the cuttings (D) may show the distributions of the lithology types (e.g., dolostone 306, limestone 308, sandstone 310, mudrock 312, uncertain category 314, unknown category 316) on the image 300.

As mentioned previously, lithology may vary continuously in the geologic formation, and cuttings at a certain depth of a well may be associated with the cuttings from the same depth of the same well or different wells. Therefore, the cutting properties of the analyzed cutting instance image may be associated with the cutting properties of other cuttings obtained from the same depth of the same well or different wells. FIG. 14 illustrates a workflow 350 used for property propagation/association. As illustrated in FIG. 14, a well 352 (well A) may be located with a displacement DX from a well 354 (well B). Cuttings may be obtained from various depths of the well 352 and the well 354. The depth direction may be along a direction 355 (e.g., Z axis), and the displacement DX may be along a direction 356 (e.g., X axis). Cutting properties of cuttings obtained from the same depth, such as depth 358, of the wells 352 and 354 may be related. The cuttings obtained from the depth 358 of the well 352 may be analyzed, and geological descriptions and/or well logs may be obtained by using the method described above in FIG. 6 to FIG. 13 and saved in an index dataset (e.g., index A).

At step 1 of the workflow 350, cuttings images for cuttings obtained from the depth 358 of the well 354 may be compared with the cuttings images of the cuttings obtained from the depth 358 of the well 352. At step 2 of the workflow 350, based on the similarity between the cuttings images from different wells, the cutting properties of the cuttings obtained from the depth 358 of the well 352 (e.g., saved in the index A), may be used in the property estimation (e.g., process 210) to obtain the cutting properties of the cuttings obtained from the depth 358 of the well 354. Cuttings from multiple wells may be analyzed and corresponding geological descriptions and/or well logs may be saved in various index datasets (e.g., index A, index B, index C) in the index storage. Index datasets in the index storage might be selected for a query in the property estimation (e.g., step 3 of the process 210) based on the similarity between the cuttings images to get a better accuracy of the property estimation.

In some embodiments, the workflow 350 in FIG. 14 may also be used to obtain well log values (e.g., in step 3 of the process 200). For example, cuttings and well log measurements may be obtained for the well 352, and cuttings may be obtained for the well 354 without well log measurements. Therefore, the well log measurements of the well 352 may be used for the well 354 based on the similarity of the cuttings from the two wells.

The techniques and system disclosed herein relate to analyzing rock cuttings and measure physical lithological features of the rock cuttings. An image analysis workflow is provided, which includes multiple computational modules to automatically extract relevant geological information from rock cuttings. Reference data, manual descriptions, and well log values are associated and used to determine rock properties of the rock cuttings. A software is developed for the image analysis, and results are displayed in various views. The results may be used to control related devices, such as the drilling system 10 and/or drilling plans of the drilling system 10 based on the rock properties (e.g., lithology) of the rock cuttings. For example, the analysis and control system 50 may automatically adjust one or more operating parameters of the drilling system 10 from which the rock cuttings are obtained based at least in part on the determined rock properties of the rock cuttings. The techniques and method disclosed herein may allow the acquisition of high quality logging curves for real-time and/or near real-time geologic formation evaluation and geosteering, which may be used to control the drilling process more efficiently and accurately. Although the examples described above are illustrated for wellbores on the land, similar method may be applied to any acquisition configuration.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

In the claims, means-plus-function clauses are intended to cover the structures described herein as performing the recited function and not only structural equivalents, but also equivalent structures. Thus, for example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

1. A method, comprising:
receiving, via an analysis and control system, a cutting instance image of a cutting of a geological formation;
extracting, via the analysis and control system, a set of cutting features from the cutting instance image, wherein the set of cutting features corresponds to a feature vector in a feature vector space;
querying, via the analysis and control system, an index dataset using the feature vector, wherein the index dataset comprises one or more reference feature vectors in the feature vector space;
identifying, via the analysis and control system, a number of reference feature vectors from the one or more reference feature vectors, wherein each of the number of reference feature vectors is associated with a respective reference cutting;
determining, via the analysis and control system, a set of cutting properties for the cutting based on the reference cuttings associated with the number of reference feature vectors; and
determining, via the analysis and control system, a categorical property for the cutting based on the set of cutting properties.

2. The method of claim 1, further comprising:
automatically adjusting, via the analysis and control system, one or more operating parameters of a drilling system from which the cutting is obtained based at least in part on the categorical property of the cutting.

3. The method of claim 1, wherein the index dataset is selected from one or more index datasets based on at least one of a geographical location of the cutting, the geological formation of the cutting, a well location of the cutting, or a depth of the cutting.

4. The method of claim 1, wherein the number of reference feature vectors are identified using a nearest neighbor search method by comparing respective distances between the feature vector and each of the one or more reference feature vectors in the index dataset in the feature vector space.

5. The method of claim 4, wherein the number of reference feature vectors corresponds to one or more classes of reference cuttings, and the categorical property is determined based on a respective number of reference feature vectors in each class of the one or more classes.

6. The method of claim 5, wherein a respective weight is calculated for each of the number of reference feature vectors using respective distances between the feature vector and each of the number of reference feature vectors.

7. The method of claim 6, wherein a respective summation of weights is calculated for each class of the one or more classes of reference cuttings, and wherein the categorical property is determined based on the respective summations of weights.

8. The method of claim 7, wherein a sub-category lithological classification is determined when at least two of the respective summations of weights are greater than a threshold.

9. The method of claim 4, wherein an unknown lithological classification is determined when the respective distances between the feature vector and each of the one or more reference feature vectors in the index dataset are less than a threshold.

10. The method of claim 7, wherein an uncertain lithological classification is determined when the respective summations of weights are less than a threshold.

11. The method of claim 1, wherein the category property is a lithological class.

12. The method of claim 1, further comprising:
determining a grain size of the cutting, wherein the grain size is used to determine the category property.

13. The method of claim 1, further comprising:
measuring physical properties of the cutting, wherein the physical properties are used to determine the category property.

14. A method, comprising:
extracting, via an analysis and control system, a respective set of reference cutting features from each of one or more reference cutting instance images of a geological formation, wherein each of the one or more reference cutting instance images is associated with a respective reference cutting, and wherein the respective set of reference cutting features corresponds to a respective reference feature vector;
determining, via the analysis and control system, a respective set of reference cutting properties for the respective reference cutting at least based on a guided property description; and
indexing, via the analysis and control system, each of the one or more reference cutting instance images with the respective set of reference cutting properties and the respective reference feature vector to generate an index dataset.

15. The method of claim 14, wherein the respective set of reference cutting properties for the respective reference cutting is determined at least based on a well log associated with the respective reference cutting.

16. The method of claim 14, wherein the guided property description comprises a respective measurement of a physical property of the respective reference cutting.

17. The method of claim 14, further comprising:
updating the index dataset by using additional reference cutting instance images.

18. A system, comprising:
a drilling device configured to acquire rock samples from a well;
an image acquisition system to obtain an image of the rock samples; and
an analysis and control system configured to:
obtain a cutting instance image for a cutting from the image of the rock samples;
extract a set of features from the cutting instance image based on reference data; and
determine a lithological classification for the cutting.

19. The system of claim 18, wherein the analysis and control system is further configured to adjust the drilling device based on the lithological classification of the rock samples.

20. The system of claim 18, wherein the analysis and control system is further configured to generate a property description at least based on a measurement of a physical property of the cutting, wherein the property description is used to determine the lithological classification for the cutting.

21. The system of claim 20, wherein the analysis and control system is further configured to display:
the image depicting one or more cutting instance images associated with corresponding cutting properties;
a lithological percentage of the rock samples; and
a multi-dimensional map of the rock samples with a plurality of cutting instance images, wherein the multi-dimensional map indicates a distribution of lithological classifications of the rock samples.
